(19) United States
(12) Patent Application Publication
(10) Pub. No.: US 2019/0285926 A1
(43) Pub. Date: Sep. 19, 2019

(54) DISPLAY PANEL

(71) Applicant: Innolux Corporation, Miao-Li County (TW)

(72) Inventors: Jui-Chu LAI, Miao-Li County (TW); Sheng-Nan FAN, Miao-Li County (TW); Chiu-Lien YANG, Miao-Li County (TW); Shih-Hsiung WU, Miao-Li County (TW); Feng-Yu LIN, Miao-Li County (TW); Kuo-Liang CHUANG, Miao-Li County (TW); Shu-Lan CHEN, Miao-Li County (TW)

(21) Appl. No.: 16/297,826

(22) Filed: Mar. 11, 2019

(30) Foreign Application Priority Data
Mar. 14, 2018 (CN) 201810209841.1

(51) Int. Cl. G02F 1/1339; G02F 1/1341

(52) U.S. Cl. CPC G02F 1/13394; G02F 2202/023; G02F 2202/28; G02F 1/1341

(57) ABSTRACT

A display panel has a display region and a non-display region. The display panel includes a first substrate; a second substrate disposed opposite to the first substrate; a display medium disposed between the first substrate and the second substrate; and an adhesion structure disposed between the first substrate and the second substrate and in the non-display region, wherein a width of the adhesion structure ranges from 5 μm to 500 μm.

This application claims the benefit of People's Republic of China application Serial No. 201810209841.1, filed Mar. 14, 2018, the subject matter of which is incorporated herein by reference.

### BACKGROUND

### Technical Field

This disclosure relates to a display panel, and more particularly to a display panel having an adhesion structure.

### Description of the Related Art

Electronic products, including smartphones, tablet computers (pads), notebook computers, monitors, televisions (TVs) and many associated products, with display panels are indispensable necessities for modern human beings in either working, processing, learning or personal entertainment. In addition to seeking for the excellent electronic properties of electronic products, such as the high quality display effect, the higher response speed in operation, the long lifetime, the high stability and the like, consumers expect to enjoy the richer and more diversified functions.

The bonding of the conventional liquid crystal display panel is performed by coating a sealant onto substrates, and then illuminating and baking the sealant so that the two substrates are bonded together. The sealant of the non-display region needs to be distant from the display region by an inactive region. In addition; the conventional method uses a dispenser to coat the sealant, and the width of the sealant is typically greater than 500 μm. Thus, the border of the manufactured display panel is wider.

### SUMMARY

This disclosure is directed to a display panel, wherein bonding and assembling between upper and lower substrates can be completed using an adhesion structure manufactured by a photo-lithography process.

According to a first aspect of this disclosure, a display panel having a display region and a non-display region is provided. The display panel includes a first substrate; a second substrate disposed opposite to the first substrate; a display medium disposed between the first substrate and the second substrate; and an adhesion structure disposed between the first substrate and the second substrate and in the non-display region; wherein a width of the adhesion structure ranges from 5 μm to 500 μm.

According to a second aspect of this disclosure, a method of assembling a display panel; the display panel having a display region and a non-display region is provided. The method includes: providing a first substrate and a second substrate; coating a photoresist material layer on the first substrate, and patterning the photoresist material layer by a photo-lithography process to form an adhesion structure corresponding to a periphery of the first substrate; assembling the first substrate, the second substrate, and the adhesion structure to form an assembled structure, so that the adhesion structure is disposed between the first substrate and the second substrate; and heating the assembled structure, so that the adhesion structure generates adhesive property and adheres to the first substrate and the second substrate, wherein a width of the adhesion structure after being adhered ranges from 5 μm to 500 μm.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIGS. 1A to 1C are schematic views showing a method of manufacturing an adhesion structure according to an embodiment of this disclosure.

FIG. 2 is a schematic cross-sectional view showing the display panel of this embodiment in this disclosure.

FIG. 3 is a schematic cross-sectional view showing another display panel of this embodiment in this disclosure.

FIG. 4 is a schematic flow chart showing a method of assembling the display panel of an embodiment in this disclosure.

FIGS. 5A and 5B are partial scanning electron microscope (SEM) photos showing the conventional sealant and the adhesion structure in this embodiment, respectively.

FIG. 6 is a current-voltage curve of the conventional sealant, the polyimide and the adhesion structure in this embodiment.

FIG. 7 is a schematic cross-sectional view showing another display panel of this embodiment in this disclosure.

FIG. 8 is a schematic cross-sectional view showing still another display panel of this embodiment in this disclosure.

FIGS. 9A and 9B are schematic views showing two aspects of the display panel applications according to this embodiment of this disclosure, respectively.

FIGS. 10A to 10C are schematic views showing three applications of the multi-screen display of the display panel of this embodiment.

FIGS. 11A to 11E are schematic views showing five shapes of the display panel applying the adhesion structure according to this embodiment of this disclosure.

### DETAILED DESCRIPTION OF THE INVENTION

In the following, various embodiments of this disclosure will be described in detail with reference to the accompanying drawings. It is to be noted that the structure, processes and contents of the implementation aspects proposed in embodiments are for illustrative purposes only, and the scope of this disclosure is not limited to the above-mentioned aspects. It is to be noted that this disclosure does not show all possible embodiments, and the structure and process of the embodiments may be changed and modified to satisfy the needs of the actual application without departing from the spirit and scope of this disclosure. Therefore, other implementations not presented in this disclosure are also applicable. Furthermore, the same or similar reference numerals in the embodiments are used to indicate the same or similar parts.

Furthermore, the terms used in the specification and the claims, such as “first”, second”, “third” and the like, are used to modify the elements of the claims, but it does not mean that it has any previous ordinal numbers on behalf of the claimed element, and also does not represent the order of one claimed element and another claimed element, or the order in the manufacturing method, and these ordinals are only used to make one claimed element with a certain name clearly distinguishable from another claimed element with the same name. In addition, when a first material layer is mentioned to be disposed on, above or over a second material layer, it may include direct contact between the first material layer and the second material layer unless otherwise defined. Alternatively, it is also possible to have one or more layers of other materials interposed, in which case there may be no direct contact between the first material layer and the second material layer.

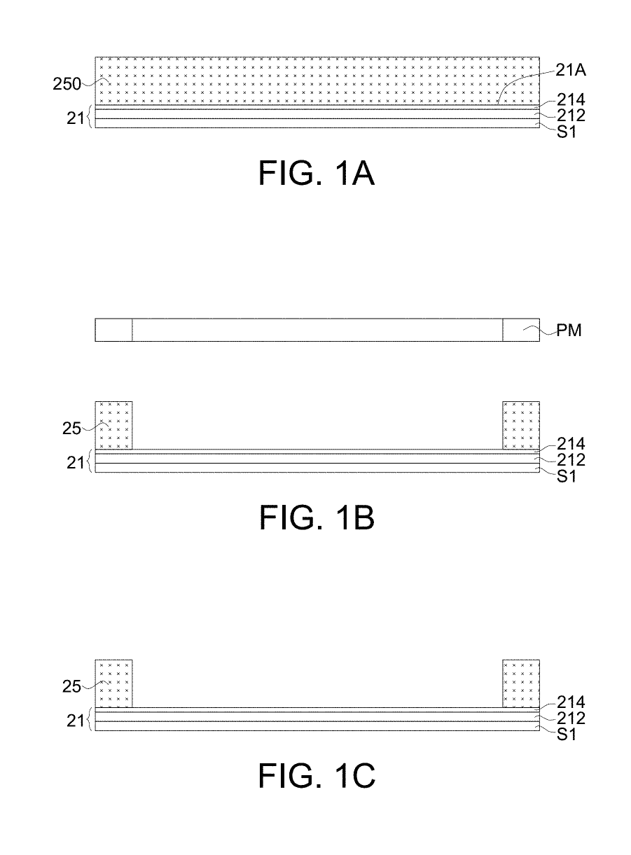

FIG. 1A to FIG. 1C are schematic views showing a method of manufacturing an adhesion structure according to an embodiment of this disclosure. In this embodiment, the adhesion structure is manufactured on the substrate by using photo-lithography processes including the use of a mask with a pattern, exposure, development, and the like. In one embodiment, a photoresist material may be coated onto a material layer on which the adhesion structure is to be formed. For example, as shown in FIG. 1A, a photoresist material layer 250 is formed, for example, coated on a first surface 21A of a first substrate 21. The first substrate 21 may be a thin-film transistor (TFT) substrate, and may include a first sub-substrate S1, a TFT layer 212 (including components such as electroconductive/insulating layers associated with thin film transistors, not shown) and a first alignment layer 214 disposed on the TFT layer 212. For example, the photoresist material layer 250 is formed on the first alignment layer 214 of the first substrate 21. The alignment layer may be, for example, a polyimide (PI) film and has completed rubbing alignment or optical alignment.

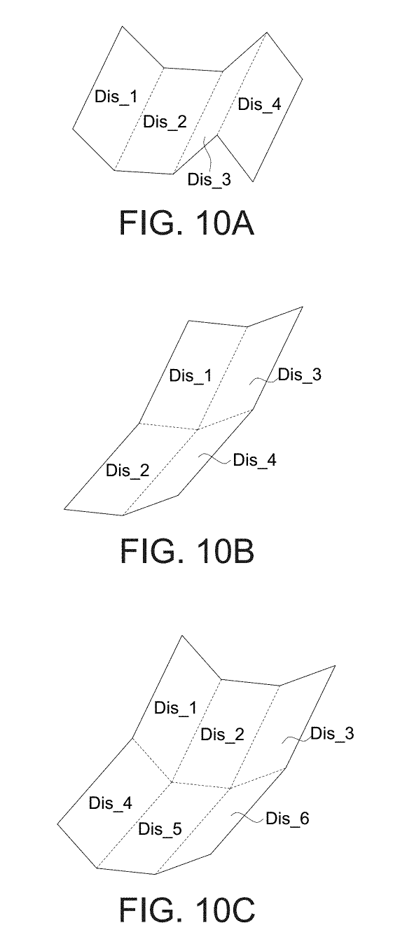

Afterward, as shown in FIG. 1B and FIG. 10, the photo-lithography process is performed on the photoresist material layer 250 by using a mask PM having a pattern. Specifically, after coating the photoresist material layer 250, a pre-bake step is performed to remove the excess solvent from the photoresist material layer 250. Next, the exposure is performed by using the mask PM. Next, the development and hard baking are performed to define the shape of an adhesion structure 25. A temperature of the hard bake may be higher than that of the pre-bake.

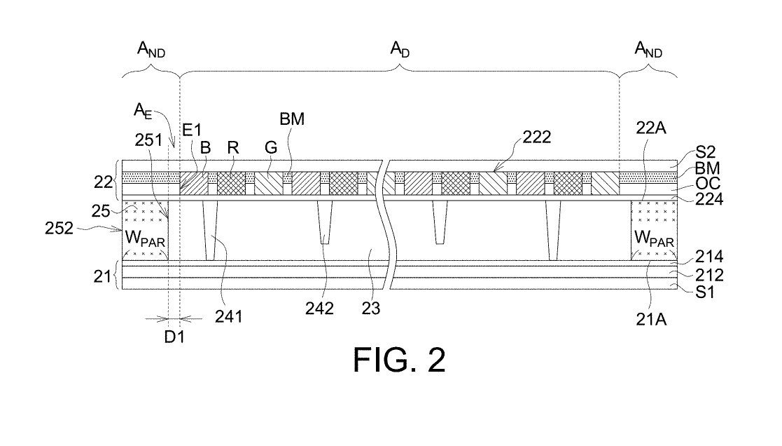

FIG. 2 is a schematic cross-sectional view showing the display panel after substrate assembly of this embodiment in this disclosure. Then, as shown in FIG. 2, a second substrate 22 is assembled with the first substrate 21, so that a second surface 22A of the second substrate 22 faces the first surface 21A of the first substrate 21. In addition, the heating at a suitable temperature is performed, so that the adhesion structure 25 generates the adhesive property and adheres to the first substrate 21 and the second substrate 22 to manufacture a display panel. The display panel has a display region A_{D} and a non-display region A_{ND} surrounding the display region A_{D}. The adhesion structure 25 is disposed on the non-display region A_{ND}, and is adhered between the first surface 21A of the first substrate 21 and the second surface 22A of the second substrate. The heating temperature may range from 140° C. to 200° C., so that the adhesion structure 25 generates the adhesive property. According to requirements, when the adhesion structure 25 is heated, a pressurized method may be also adopted at the same time to make the adhesion structure 25 generate the adhesive property.

The second substrate 22 may be a color filter (CF) substrate. For example, the second substrate 22 may include a second sub-substrate S2, a filter layer 222, the main spacers 241 (defining and maintaining the cell gap of the display panel), the sub-spacers 242, a second alignment layer 224, and related components such as electrodes or other structures (not shown). The filter layer 222 may include multiple color filter units (such as a blue filter unit B, a red filter unit R and a green filter unit G), a protection film (such as a planarization layer OC), and a black matrix layer BM. The black matrix layer BM is located between the color filter units to avoid false color mixing and light-leakage. The black matrix layer BM is also located at the non-display region A_{ND}. In other embodiments, the filter layer 222, the main spacers 241, the sub-spacers 242 and the like may be modified to be disposed on the first substrate 21, and may be combined with a thin film transistor layer.

According to this embodiment, the adhesion structure 25 includes a photoresist material, such as an adhesive material. In an embodiment, the adhesion structure 25 is a patternable adhesive resin (PAR), which has the property that can be formed by photo-lithography process. In one example, the adhesion structure 25 includes silicone resin. The adhesive materials used in this disclosure can be processed at different temperatures for the formation and substrate assembly. For example, the temperature in the process (e.g., the photo-lithography process) before substrate assembly can be not greater than 140° C. to complete the formation of the adhesion structure 25 without generating the adhesive property. During substrate assembly process, the temperature higher than 140° C. may be applied to make the adhesion structure 25 generate the adhesive property. In an embodiment, the adhesion structure 25 can generate adhesive property at the temperature ranging from 140° C. to 200° C. Therefore, during substrate assembly, the adhesion structure 25 may be heated in the range from 140° C. to 200° C. to make the adhesion structure 25 generate the adhesive property. Alternatively, according to other embodiments, the heating temperature to the adhesion structure 25 may be higher than 200° C., but lower than a critical temperature at which the associated components in the display panel deform and the electrical performance and the display quality of the panel is affected.

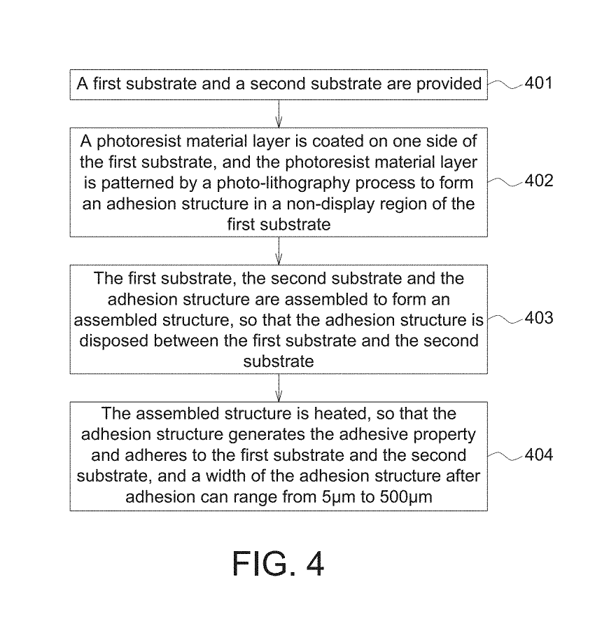

FIG. 4 is a schematic flow chart showing a method of assembling the display panel of an embodiment in this disclosure. As shown in step 401, a first substrate and a second substrate are provided. As shown in step 402, a photoresist material layer is coated on one side of the first substrate, and the photoresist material layer is patterned by a photo-lithography process to form an adhesion structure in a non-display region of the first substrate. As shown in step 403, the first substrate, the second substrate, and the adhesion structure are assembled to form an assembled structure, so that the adhesion structure is disposed between the first substrate and the second substrate. As shown in step 404, the assembled structure is heated, so that the adhesion structure generates the adhesive property and adheres to the first substrate and the second substrate. A width of the adhesion structure after adhesion can range from 5 μm to 500 μm.

Please refer back to FIG. 2, which shows the display panel after assembly of the substrates. The adhesion structure 25 in this embodiment may be located at the non-display region A_{ND}. As shown in FIG. 2, the display panel of this embodiment includes the first substrate 21, the second substrate 22 disposed opposite to the first substrate 21, a display medium 23 (e.g., including liquid crystal) disposed between the first substrate 21 and the second substrate 22, and an adhesion structure 25 disposed between the first substrate 21 and the second substrate 22 and corresponding to peripheries of the first substrate 21 and the second substrate 22. According to some embodiments in this disclosure, the patterns of the adhesion structure 25 (including the width, the position and other physical properties of the pattern) may be defined by the photo-lithography process, so as to precisely control the width, the position and the shape of the adhesion structure 25. Therefore, the width of the adhesion structure 25 may be smaller than the width of the conventional sealant, the width W_{PAR} of the adhesion structure 25 may range from 5 μm to 500 μm, and the actual width may be determined based on the product design of the application. In one embodiment, the width W_{PAR} of the adhesion structure 25 ranges from 5 μm to 400 μm. In another embodiment, the width W_{PAR} of the adhesion structure 25 ranges from 5 μm to 300 μm (e.g., from 5 μm to 200 μm, from 5 μm to 100 μm or from 5 μm to 50 μm).

Furthermore, the display panel has a display region A_{D} and a non-display region A_{ND} surrounding the display region A_{D}, and the display region A_{D} has an outer side E1 The adhesion structure 25 is located at the non-display region A_{ND}, the adhesion structure 25 has a first edge 251 and a second edge 252, and the first edge 251 is closer to the outer side E1 of the display region relative to the second edge 252. An region between the adhesion structure 25 and the display region AD defines an inactive region A_{E}, For example, as shown in FIG. 2, the outer side E1 may be the edge of an outermost color filter unit (the color is not limited) in the display region, such as the edge of the blue filter unit B shown in the figure. The distance D1 (i.e., the distance of the inactive region A_{E}) between the first edge 251 and the outer side E1 may be very small. For example, D1 may not exceed 5 μm; and D1 may be greater than or equal to 0, but smaller than or equal to 5 μm. In practical applications, the human eyes almost cannot recognize the distance of 5 μm, so that the distance equal to or smaller than 5 μm can be considered as no distance, and the very narrow or borderless visual effect can be achieved. In one embodiment, the distance D1 from the first edge 251 of the adhesion structure 25 to the outer side E1 of the display region AD may be smaller than or equal to 1/50 (or even 1/100) of the width W_{PAR} of the adhesion structure to function as a buffer region for process variations. Therefore, according to an embodiment, if the width W_{PAR} of adhesion structure 25 is equal to, for example, 200 μm or 300 μm, then only 2 μm or 3 μm of the distance D1 (or D1 may be smaller than 2 μm or 3 μm) is needed as the width of the buffer region for the process variations.

In the case where the sealant is conventionally used for bonding a substrate, the width of the sealant itself is wider. Moreover, due to the consideration of the variation of the sealant, the range of the non-display region needs to include the inactive region of a considerable width in addition to the range of the sealant itself (the width of the inactive region is at least ±20% of the width of the sealant), and it is not advantageous to the manufacturing of a narrow border display panel. In contrast, according to some embodiments of the present disclosure, the adhesion structure having a smaller width is used to replace the conventional sealant, and the distance of the inactive region may be controlled to be very small, and may reach almost zero. This allows the product applying the display panel to achieve a narrow border or borderless effect, thereby implementing a full-screen display.

This disclosure is not limited to the aspect shown in FIG. 2. Other display panels (especially liquid crystal display panels), which use the conventional sealant to bond the substrate, are all applicable aspects of this disclosure. According to some embodiments, the first substrate may be a color filter substrate, and the second substrate may be a thin film transistor substrate. According to some embodiments, the following aspects may be applied: the color filter layer may be directly integrated on the thin film transistor matrix substrate (color filter on array, COA) or the black matrix layer is formed on the thin film transistor matrix substrate (black matrix on array, BOA) and the like. In the manufacture of the liquid crystal display panel, the COA substrate or the BOA substrate is assembled with another substrate without the color filter layer or the black matrix layer, and the liquid crystals are filled between the two substrates. In addition, for example, an aspect of a display panel filled with a self-alignment LC and without an alignment film may also be applied, wherein the adhesion structure of this embodiment is disposed on an insulating layer (such as a silicon nitride layer or an oxynitride layer) rather than disposed on the alignment film. The locations where the original peripheral sealants are disposed in these application can be replaced by the adhesion structures of the embodiments.

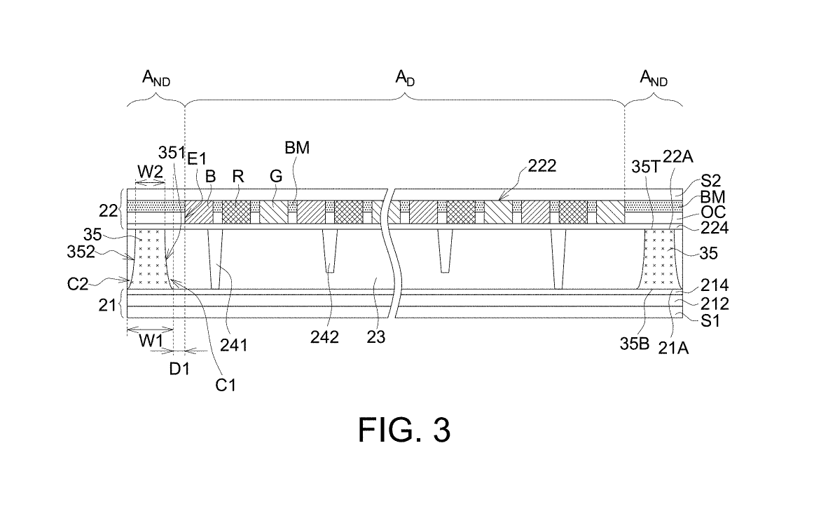

In the display panel of FIG. 2, the first edge 251 and the second edge 252 of the adhesion structure 25 are shown as straight lines. In other embodiments, however, the edge of the adhesion structure 25 obtained is not necessarily the straight line and can be modified according to the selection and the adjustment of the adhesive material and/or the photo-lithography process. FIG. 3 is a schematic cross-sectional view of another display panel of this embodiment in this disclosure. In some embodiments, at least a portion of a first edge 351 of an adhesion structure 35 has a curved shape, and at least a portion of a second edge 352 has a curved shape, as shown in FIG. 3.

Referring specifically to FIG. 3, the adhesion structure 35 has a top portion 35T and a bottom portion 35B, the top portion 35T contacts or is disposed adjacent to the second surface 22A of the second substrate 22, and the bottom portion 35B contacts or is disposed adjacent to the first surface 21A of the first substrate 21. The bottom portion 35B of the adhesion structure 35 has a first width W1, the top portion 35T has a second width W2, and the first width W1 and the second width W2 may be different. For example, the first width W1 may be greater than the second width W2. For example, the adhesion structure 35 may have a gradually decreasing width from the bottom portion 35B towards the top portion 35T. An included angle between the first edge 351 and the bottom portion 35B may be smaller than 90 degrees, and the included angle between the second edge 352 and the bottom portion 35B may be smaller than 90 degrees. The first edge 351 may have a concave arc shape C1, and the second edge 352 may have a concave arc shape C2.

According to other embodiments, although not shown in figures, there is no need that both of the first edge and the second edge of the adhesion structure have curved shapes. That is, only one of the edges may have a curved shape, and the other one of the edges does not have curved shape. For example, the first edge 351 of the adhesion structure 35 may have a curved shape, an included angle between the first edge 351 and the bottom portion 35B may be smaller than 90 degrees, and the first edge 351 may have a concave shape. However, the second edge 352 may be a straight line formed by cutting or other methods.

Furthermore, in the application of the conventional display device, in order to prevent the sealant from overflowing, a dam structure is added between the display element and the sealant to prevent the sealant, which has not yet cured, from deforming and overflowing to the display region when the substrates are assembled and pressed upon each other. In contrast, in some embodiments of the present disclosure, after the adhesion structure is formed by the photo-lithography process, the shape of the adhesion structure is finished. When the substrates are assembled or pressed upon each other, the adhesion structure is free from the overflow problem of the conventional sealant, and the dam structure also needs not to be added, so that the size of the region for surrounding the display region is reduced.

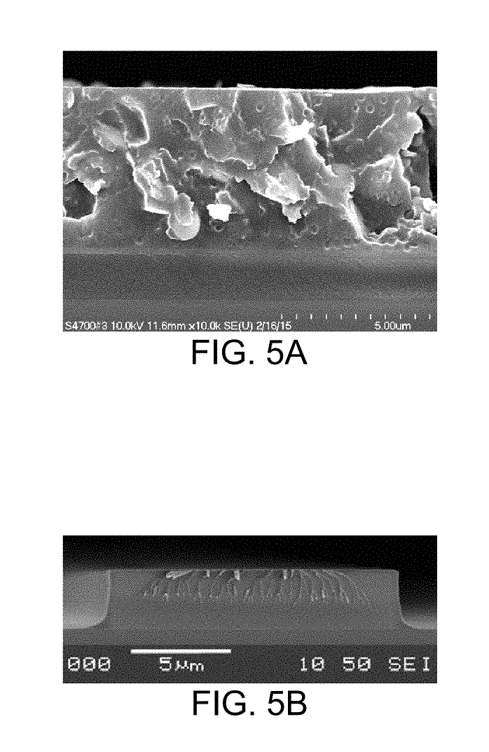

Compared with the conventional sealant, in addition to the different ingredients, the adhesion structure 25 of this embodiment also has excellent performance of water blocking property. Please refer to FIG. 5A and FIG. 5B. FIG. 5A and FIG. 5B are partial scanning electron microscope (SEM) photos showing the conventional sealant and the adhesion structure in this embodiment, respectively. Tables 1 and 2 list ingredients of a conventional sealant and one of exemplified adhesion structures in this embodiment, respectively. However, the ingredients in the Table 2 are provided only for the purpose of exemplified descriptions without restricting the scope of this disclosure. Furthermore, the solvent in the Table 2 is removed in the pre-bake step. The main ingredients of the conventional sealant are epoxy resin and acrylic, it can be seen from the SEM photo (FIG. 5A) that the sealant structure is more loose, and fillers are blended within the sealant to improve the overall water-oxygen blocking property. However, the adhesion structure 25 of an embodiment is patternable adhesive resin (PAR), and the main ingredient of its material is silicone resin. It can be seen from the SEM photo (FIG. 5B) that its cross-sectional view presents the dense structure, and is clean without mixture/filler blended therein. Therefore, the water-oxygen blocking property of the adhesion structure 25 of this embodiment is even better than that of the conventional sealant. In addition, in a water absorption test, the water absorption of the conventional sealant and the water absorption of the adhesion structure 25 of this embodiment are equal to 4.96% and 0.3% respectively, and the difference is great (the water absorption of the sealant is about 16.5 times of the water absorption of the adhesion structure). Therefore, it also can be seen that the conventional sealant absorbs water more easily than the material of the adhesion structure 25 of this embodiment. The adhesion structure of this disclosure has better water blocking property, so that the lifetime of the display device can be lengthened, and the stable and excellent display quality can be achieved.

TABLE 1

| Ingredients | Content (%) |
|---|---|
| Epoxy acrylate oligomers | 60-70 |
| Fillers | 20-30 |
| Curing agents | 5-15 |
| Other additive agents | 1-10 |
| Total amount | 100 |

TABLE 2

| | Concentration |
|---|---|
| Ingredients | (wt %) |
| SiH group containing siloxane compound | 25-35 |
| Propylene glycol monomethyl ether acetate | 55-65 |
| (PGMEA) solvent | |
| Isobutyl isobutyrate (IBIB) solvent | 5-10 |

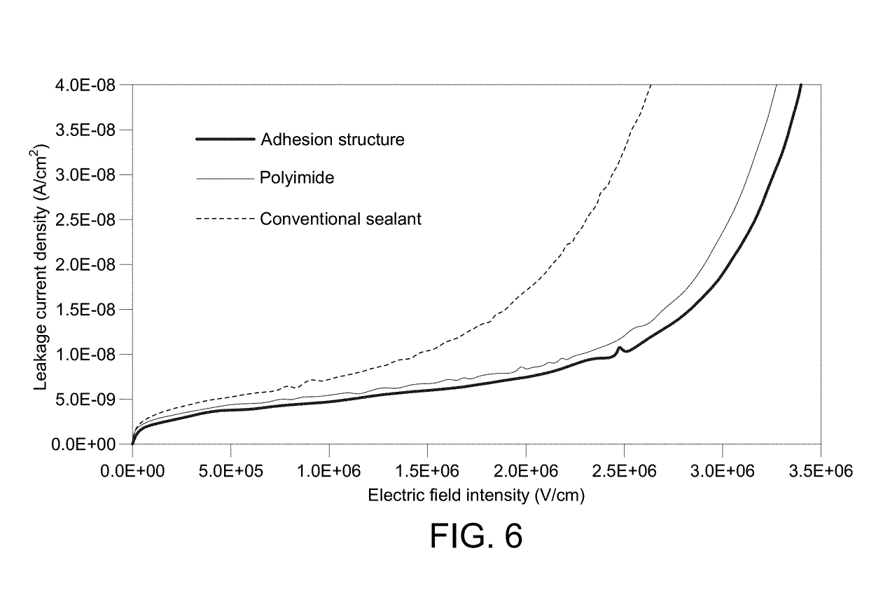

In addition, because volume resistivities of the conventional sealant and the adhesion structure 25 of this embodiment are different, the volume resistivity of the sealant is smaller than 10¹³ Ω·cm, and the volume resistivity of the adhesion structure 25 is greater than 10¹⁴ Ω·cm, so that the current-voltage (I-V curve) properties are different. FIG. 6 shows the current-voltage curves of the conventional sealant, polyimide (PI) and the adhesion structure of this embodiment, wherein the horizontal axis represents the electric field intensity (V/cm), and the vertical axis represents the leakage current density (A/cm²). Under the same electric field intensity, the leakage current density of the adhesion structure of this embodiment is smaller than the leakage current density of the conventional sealant.

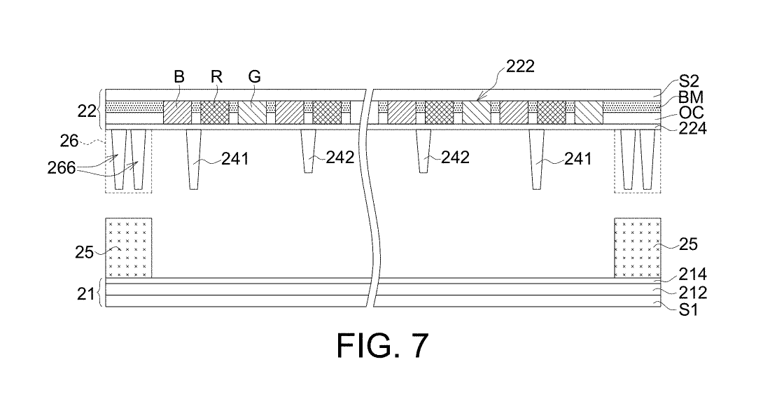

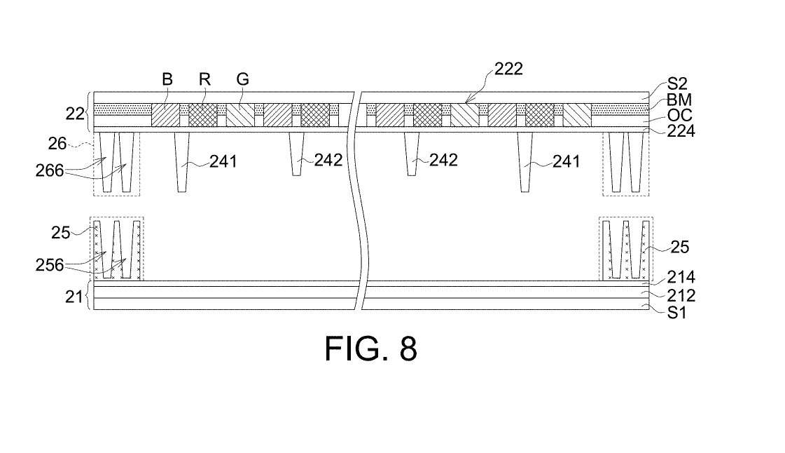

FIG. 7 is a schematic cross-sectional view showing another display panel of this embodiment in this disclosure, wherein a photo-spacer 26 is added and disposed corresponding to the adhesion structure 25 of this embodiment. FIG. 8 is a schematic cross-sectional view showing still another display panel of this embodiment in this disclosure. In the example of FIG. 8, the photo-spacer 26 includes a plurality of protruding portions 266, and the adhesion structure 25 includes a plurality of recessed portions 256. After the upper and lower substrates are assembled to each other, the protruding portions 266 are accommodated within the corresponding recessed portions 256. After the adhesion structure 25 generates the adhesive property by heating (e.g., exceeding the temperature of 140° C.), the recessed portions 256 of the adhesion structure 25 are adhered to the protruding portions 266 of the photo-spacer 26. Thus, the bonding area of the adhesion structure 25 is enlarged to increase the bonding strength between the upper and lower substrates. Of course, the structure type of the photo-spacer 26 and the adhesion structure 25 shown in FIG. 7 and FIG. 8 (e.g., the length/width of the photo-spacer 26, the depth/width of the recessed portion 256, or the like) are provided as examples without restricting the scope of this disclosure. Any modification, which can enlarge the bonding area of the adhesion structure and increase the bonding strength between the upper and lower substrates, also pertains to the applicable range of this disclosure.

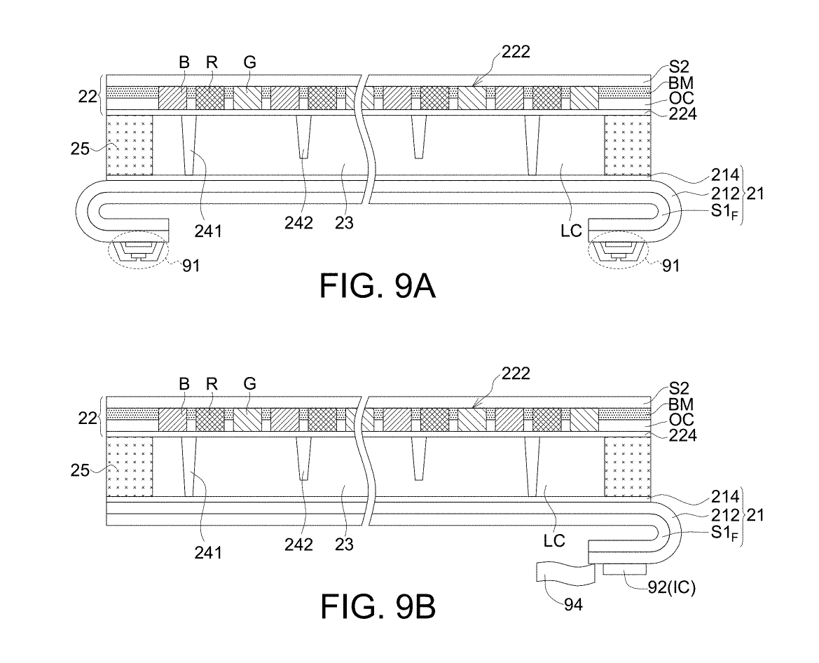

In addition, the embodiment of this disclosure may also be applied to the display panel having a flexible substrate serving as at least one of the two assembled substrates. FIG. 9A and FIG. 9B are schematic views showing two of the display panel applications according to some embodiments of this disclosure, respectively. As shown in FIG. 9A, for example, the first substrate 21 includes a flexible sub-substrate S1_{F}, a TFT layer 212 (including elements of conductive/insulating layers associated with the thin film transistor, not shown), a first alignment layer 214 disposed on the TFT layer 212, and the adhesion structure 25 of this embodiment disposed on the first alignment layer 214. A drive circuit 91 (e.g., TFT gate drive circuit) is disposed on the flexible sub-substrate S1_{F} in a peripheral region and outside the adhesion structure 25. The flexible sub-substrate S1_{F} is bent backwards to make the drive circuit 91 be disposed on the backside of the display region. Similar to FIG. 9A, in FIG. 9B, a drive circuit 92 is disposed on the flexible sub-substrate S1_{F}, which is bent backwards and then connected to a flexible circuit board (FPC) 94. These aspects can be implemented in the full screen display of the display panel, and the arrangement of the display device can also be modified in various applications. Noted that although the embodiment may be applied to a display device having a flexible substrate, this disclosure is not limited thereto. The embodiment may also be applied to a display device having a rigid substrate, or a display device having a flexible substrate serving as one of the upper and lower substrates. Furthermore, the switch element disposed on the substrate of the display device in the embodiment of this disclosure is, for example but without limitation to, the thin film transistor. The type of the thin film transistor is not particularly limited. For example, the type of the thin film transistors can be back channel etch, etch-stop layer, top-gate, or bottom-gate. The semiconductor layer material of the thin film transistor is also not limited, and can be, for example, amorphous silicon, polysilicon, or metal oxide.

As mentioned hereinabove, the narrow border or borderless display panel can be manufactured using the adhesion structure of this embodiment. The display may have multiple screens by tiling multiple display panels together. FIG. 10A to FIG. 100 are schematic views showing three applications of the multi-screen display of the display panel of this embodiment. Each multi-screen display includes multiple display panels of this embodiment, such as four display panels Dis_1 to Dis_4 of FIG. 10A and FIG. 10B, and six display panels Dis_1 to Dis_6 (or other numbers of display panels are also applicable) of FIG. 100. Each multi-screen display may be formed to be foldable to reduce the total volume of the display and reduce the space for transportation and storage. In practical application, the folding of these display panels may be achieved according to the designs of the associated mechanism members (e.g., the frame for placement of the display panel, not shown). FIG. 10A to FIG. 100 only simply depict the display panels to facilitate the demonstrations of the relative positions and schematic folds between the display panels.

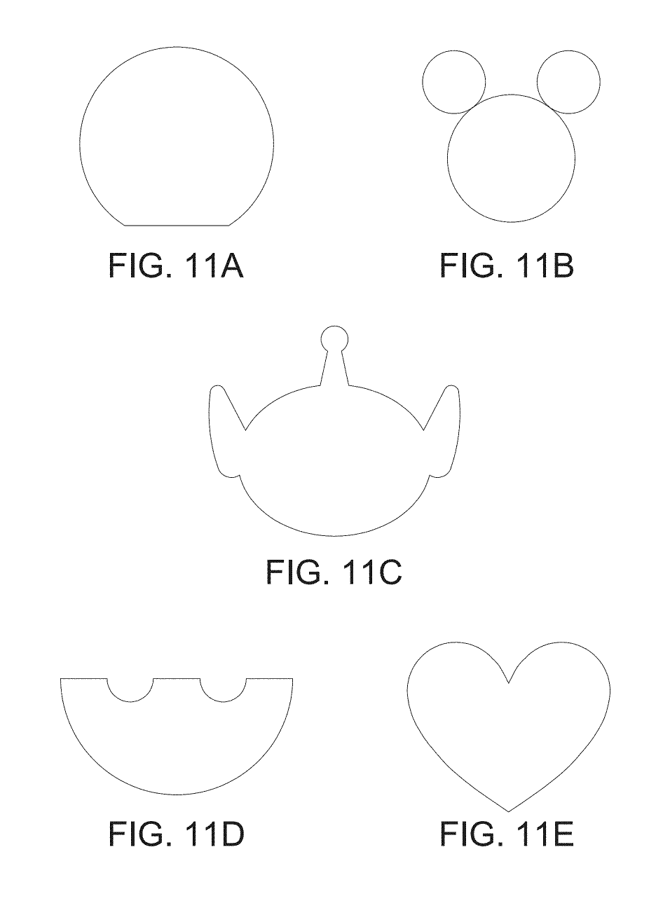

Furthermore, because the adhesion structure of this embodiment can be formed by the photo-lithography process (e.g., the use of the patterned mask, exposure and development), and the formed pattern of the adhesion structure is determined by the pattern of the mask, the adhesion structure can have any shape. In contrast, the conventional sealant cannot be any shape. Thus, using the adhesion structure of this embodiment of this disclosure, the display panel can have any free form or shape. FIG. 11A to FIG. 11E are schematic views showing five shapes of the display panel applying the adhesion structure according to this embodiment of this disclosure. In addition to the common rectangle, the display panel applying the adhesion structure of this embodiment of this disclosure may have any shape according to the product requirements, and the adhesion structure of this embodiment can match with any shape of the applied display panel through the pattern of the mask and the photo-lithography process. The edges of the display panel shown in FIG. 11A to FIG. 11E may be an arbitrary combination of curves and straight lines. The product combining multiple display panels is also applicable. For example, the application product in FIG. 11B has the shape of the Cartoon character Mickey Mouse, and three circular display panels of the embodiments can be properly combined, wherein the three display panels can be electrically controlled independently. As shown in the application product of FIG. 11C, the product can be formed by using one single irregularly shaped display panel of the embodiment, wherein the shape of the adhesion structure can match with the shape of the display panel.

In summary, according to some embodiments, the adhesion structure of this disclosure can be formed by the photo-lithography process so that the adhesion structure with the narrower width can be obtained, and the narrow border or borderless display panel can be manufactured. According to some embodiments, the adhesion structure of this disclosure can be formed by the photo-lithography process, so that the pattern of the adhesion structure can match with the shape of the display panel, and the display panel with free form can be manufactured. According to some embodiments, the adhesion structure of this disclosure has the better water blocking property, and can lengthen the lifetime of the display device.

Other embodiments (e.g., known members of elements have different configurations, arrangements and the like) are also applicable, wherein appropriate adjustments or changes depending on actual needs and conditions can be made upon the application. For example, although the alignment film is depicted and the adhesion structure of this embodiment is disposed on the alignment film in the drawings of the above-mentioned embodiments, this disclosure is not limited thereto. The adhesion structure of this embodiment may be provided according to the requirements of the application aspects (e.g., for the application aspect of the substrate without the alignment film, the adhesion structures may be disposed at suitable positions on an insulating layer to complete the substrate assembly), and these aspects pertain to the application of this disclosure. Therefore, the structure shown in the specification and drawings is for illustrative purposes only and is not intended to limit the scope of this disclosure. In addition, those skilled in the art should understand that, the shape and position of the constituent components in this embodiment are also not limited to those illustrated in the drawings, may also be adjusted according to the needs and/or manufacturing steps of the actual application without departing from the spirit of the disclosure.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display panel having a display region and a non-display region, the display panel comprising:
a first substrate;
a second substrate, disposed opposite to the first substrate;
a display medium, disposed between the first substrate and the second substrate; and
an adhesion structure, disposed between the first substrate and the second substrate and in the non-display region, wherein a width of the adhesion structure ranges from 5 μm to 500 μm.

2. The display panel according to claim 1, wherein the adhesion structure comprises a photoresist material.

3. The display panel according to claim 1, wherein the adhesion structure comprises silicone resin.

4. The display panel according to claim 1, wherein the width of the adhesion structure ranges from 5 μm to 50 μm.

5. The display panel according to claim 1, wherein the adhesion structure is formed by heating a preliminary pattern at a temperature of 140° C. to 200° C.

6. The display panel according to claim 1, wherein the adhesion structure has adhesive property at a temperature ranging from 140° C. to 200° C.

7. The display panel according to claim 1, wherein the non-display region surrounds the display region.

8. The display panel according to claim 1, wherein the adhesion structure has a first edge and a second edge, the first edge is closer to an outer side of the display region, and at least a portion of the first edge has a curved shape.

9. The display panel according to claim 1, wherein the adhesion structure has a first edge and a second edge, the first edge is closer to an outer side of the display region, and a first distance from the first edge to the outer side of the display region is smaller than or equal to 5 μm.

10. The display panel according to claim 1, wherein the adhesion structure has a first edge and a second edge, the first edge is closer to an outer side of the display region, and a distance from the first edge to the outer side of the display region is smaller than or equal to 1/100 of the width of the adhesion structure.

11. The display panel according to claim 1, wherein the adhesion structure has a bottom portion closer to the first substrate and a top portion closer to the second substrate, and a first width of the bottom portion is different from a second width of the top portion.

12. The display panel according to claim 11, wherein the first width is greater than the second width.

13. The display panel according to claim 1, further comprising a first photo-spacer disposed between the first substrate and the second substrate and in the display region.

14. The display panel according to claim 1, further comprising a second photo-spacer disposed between the first substrate and the second substrate and in the non-display region.

15. The display panel according to claim 14, wherein the second photo-spacer 26 is disposed corresponding to the adhesion structure.

16. The display panel according to claim 15, wherein the second photo-spacer comprises a plurality of protruding portions, the adhesion structure comprises a plurality of recessed portions, and the protruding portions are accommodated within and adheres to the recessed portions.

17. A method of assembling a display panel, the display panel having a display region and a non-display region, the method comprising:
providing a first substrate and a second substrate;
coating a photoresist material layer on the first substrate, and patterning the photoresist material layer by a photo-lithography process to form an adhesion structure in a non-display region of the first substrate;
assembling the first substrate, the second substrate, and the adhesion structure to form an assembled structure, so that the adhesion structure is disposed between the first substrate and the second substrate; and
heating the assembled structure, so that the adhesion structure generates adhesive property and adheres to the first substrate and the second substrate, wherein a width of the adhesion structure after adhesion ranges from 5 μm to 500 μm.

18. The method according to claim 17, wherein patterning the photoresist material layer includes exposing and developing the photoresist material layer.

19. The method according to claim 17, wherein heating the assembled structure includes heating in a temperature range from 140° C. to 200° C.

20. The method according to claim 17, further comprising disposing a display medium between the first substrate and the second substrate.
